(19) United States
(12) Patent Application Publication
(10) Pub. No.: US 2007/0061590 A1
(43) Pub. Date: Mar. 15, 2007

(54) Secure biometric authentication system

(76) Inventors: Dag Eivind Boye, Euless, TX (US); David DuWayne Wise, Bedford, TX (US)

Correspondence Address: CASH KLEMCHUK POWERS TAYLOR LLP, CAMPBELL CENTRE II, 8150 NORTH CENTRAL EXPRESSWAY, SUITE 1575, DALLAS, TX, 75206, US

(21) Appl. No.: 11/225,276

(22) Filed: Sep. 13, 2005

(51) Int. Cl. H04K 1/00

(52) U.S. Cl. 713/186

(57) ABSTRACT

A system and method for authentication a user's identity via biometrics is disclosed. The system includes client software, an authentication server, and an independent biometric services server. Data associated with the biometric samples provided by a user are stored in the biometric services server and the user is assigned a unique identifier. The authentication server stores biometric templates consisting of information regarding the biometric samples and type of samples, e.g. voice, retina scans, fingerprints, DNA, etc. The authentication server also stores at least one pointer to the biometrics services server providing a link between the biometric samples stored in the biometric services server and the user's biometric template(s). Identity authentication is accomplished by a series of steps including querying the user for an identifier and analyzing a biometric sample provided by the user with the biometric samples stored in the biometric services server. Once the user has been authenticated, a service provider can then securely provide services to and exchange information with the user. A system and method for enrolling a user into the biometric authentication system is also disclosed.

### BACKGROUND

1. Field of the Invention

The present invention relates generally to authenticating the identity of a user and in particular, to securely and accurately authenticating the identity of a user using biometric data and analysis.

2. Background of the Invention

The advent of the Internet and advances in mobile telecommunications have provided an explosion of services, which may be provided to users without need for a face-to-face transaction. For example, users commonly conduct commercial and banking transactions online over the Internet. Users also frequently use cellular telephones and networks to confirm or establish a reservation for hotel, travel, auction buying, or any other form of secured transaction. The Internet and email can be used to provide “digital signatures” for signing documents that are unique to a user. However, these services have lead to identity theft and users pretending to be persons or users they are not. To combat this, service providers have employed a variety of methods to verify and authenticate the identity of users.

In one common method, a two-step process is employed. First, in the enrollment phase, the service provider verifies that a user is the person he claims to be. This is done typically by credit card information, email address, etc. or by an unsupported affirmation from the user. Once the service provider is satisfied with the authentication of the user's identity, the service provider typically assigns the user a unique user identifier and password pair. In the second phase, the service provider requires the user to identify himself using a registered identifier. Upon receipt of a valid registered identifier and a matching password, the service provider authenticates the identity and provides services to the user. This method suffers from a number of shortcomings, including being susceptible to imposters who have learned the identifier and password of registered users and being susceptible to other imposters who register themselves as persons they are not. Other shortcomings with this approach include password manipulation and user identifier information theft. Additionally, a user typically is required to store securely a multitude of user identifier and password pairs corresponding to the number of service providers through which the user conducts business. This is cumbersome and can lead to lost passwords and identifiers.

Another approach to authentication is through the use of digital certificates. Typically, a trusted certificate authority provider verifies the identity of the user and issues the user a digital certificate. A second user entering into a transaction with the first user can verify the first user's identity by either viewing the first user's digital certificate or having the first user forward a digital certificate to the second user. A drawback to this approach is that someone wishing to pose as the first user need only get access to the first user's computer, in which the first user's digital certificate would typically be stored, or otherwise get access to the first user's digital certificate if it is stored elsewhere.

Yet another approach to securing communications and authenticating identities is through the use of public key cryptography and public key infrastructures (“PKI”). PKI includes the use of asymmetric public keys and private keys (i.e. key pairs). An example framework for implementation of a public key cryptography is set forth in the public domain Public Key Cryptography Standards (PKCS), provided by RSA Security, Inc., the contents of which are incorporated herein by reference. Additional information regarding the use of PKI and its shortcomings are discussed in U.S. Patent Application No. 2004/0059924 A1 filed by Soto et al.

Despite these efforts, problems remain. The premises behind the present day transaction security systems on the Internet is that the legitimate user either possess something known (the private key), or has been entrusted with a password or token, which decrypts the user's private key, or grants access to it through the use of conventional encryption techniques. This private key can be embedded in the contents of a digital certificate (in the case of a web browser) or can be encrypted in a handheld or computer device, such as Smart Cards, magnetic strips, or other electronic devices. In all of these scenarios, the assumption is that the user protects these devices and keys from theft through personal possession and safeguarding. However, in today's networking environment, these tokens can be compromised by careless control by the user, or by direct theft or password manipulation.

To overcome these security problems, biometric analysis has been implemented as an additional measure to authenticate a user's identity. In this approach, a user typically submits a biometric specimen as a control that is later compared with a subsequent sample to verify the identity of the user. For example, U.S. Patent Application No. 2002/0147914 A1 filed by Arnold employs biometric analysis of voice samples to identify a user. U.S. Pat. No. 6,076,167 to Borza employs fingerprint analysis to authenticate a user. Other approaches to authenticating identity using biometrics include U.S. Pat. No. 5,987,232 to Tabuki, U.S. Patent Application No. 2003/0105966 A1 filed by Pu et al., and U.S. Patent Application No. 2004/0250085 A1 filed by Tattan. Soto, discussed above, also addresses the use of a biometric private key infrastructure and proposes the use of a private biometric key infrastructure in conjunction with commonly practiced PKI security measures.

All references cited herein are incorporated by reference to the maximum extent allowable by law. To the extent a reference may not be fully incorporated herein, it is incorporated by reference for background purposes and indicative of the knowledge of one of ordinary skill in the art.

However, each of the above references suffers from one or more of the following disadvantages. First, often the biometric identification data used for authenticating a later supplied biometric sample is stored with the server that conducts the authentication operation. This enhances the risk that a third party could hack into the authentication server and retrieve not only user identifiers and password data, but also the biometric identification data and information associated with them. Second, in some cases, a user is not required to be authenticated as a valid, registered user before submitting a biometric sample for analysis and identity authentication. Third, often the user is not required to submit a unique verifiable code, generated after the user successfully logs onto the authentication system, before presenting a biometric sample. This makes the step of submitting the biometric sample less secure and more vulnerable to third parties. Fourth, in some cases, insufficient information may be collected regarding the identity of the user to reliably and accurately verify the actual user identity during the enrollment stage prior to submitting biometric identification data. If this occurs, imposters may become enrolled under false identities, yet have workable identities supported by biometric verification processes.

A need exists, therefore, for a system and method that enable a user to easily interface with a service provider in a secure manner and provides the service provider with reliable authentication of the user's identity. A need also exists for a biometric authentication system and method that secure the biometric identification data supplied by a user from unauthorized access by hackers and other unauthorized persons and systems.

A need also exists for a biometric authentication system and method that verify that the user is a valid, registered user before the user is allowed to submit a biometric sample for authentication. A need also exists for a biometric authentication system and method that require a user to submit a unique code before submitting a biometric sample for authentication.

A need also exists for a biometric authentication system and method that employ a reliable method of enrolling and registering users to ensure that registered users are the persons claimed and that the biometric identification data submitted during enrollment is associated with the claimed identities.

A need also exists for an identity authentication system that provides a user a single identifier that may be used with a plurality of service providers. A need also exists for an authentication system that securely stores current personal information associated with a user in a central location that can be made available to a plurality of service providers and may be updated and kept current by the user.

### SUMMARY

The problems related to reliably authenticating user identity via biometric analysis and maintaining security of the authentication system discussed above are solved by the systems and methods of the present invention. In accordance with one embodiment of the present invention, client software is provided, which queries the user for his identifier and optionally a password associated with the identifier. A first computer server, referred to as the master authentication server, and a second computer server, referred to as the biometric services server, are also provided. The user is queried for a unique identifier associated with the user. The client passes the identifier to the master authentication server and requests the server to authenticate the user's identity. The master authentication server selects at least one biometric template associated with the user's identifier through which the user will be biometrically authenticated.

After selecting the biometric template, the master authentication server communicates with the biometric services server requesting it to perform a biometric authentication process. The biometric services server selects certain biometric data stored in the biometric services server associated with the biometric template. The biometric services server then initiates communication with the user and collects a biometric sample of a pre-determined type from the user. Next, the biometric services server compares the biometric sample with the biometric data associated with the user and verifies whether there is a match. If there is a match, the biometric services server generates an authentication report, which grants the user access to the service provider.

In another embodiment of the invention, a challenge code/response code is employed to heighten security. After receiving the user's identifier, the client generates a unique response code and communicates it to the master authentication server, which communicates the response code to the biometric services server. The client also queries the user to input the response code, unknown to the user until after the user has been biometrically authenticated. After receiving an authentication request from the master authentication server, the biometric services server generates a unique challenge code associated with the response code and communicates the challenge code to the client. The client in turn communicates the challenge code to the user.

After the biometric services server initiates communication with the user, it queries the user for the challenge code. After receiving the proper challenge code, the biometric services performs the biometric authentication and if authentication is successful, provides the user with the response code. After entry of the response code, the client provides the user access to the service provider.

In another embodiment of the present invention, the biometric services server initiates contact with the user via telephone call and prompts the user for the challenge code. After submitting the correct challenge code, the user supplies one or more voice samples for analysis and authentication. In other embodiments of the present invention, the biometric services server prompts the user for input of fingerprint samples, retina and eye scan samples, face scan samples, or other suitable biometric samples.

The client software, master authentication server, and biometrics services server as well as the service provider are connected by various secured network systems and methods to form a client/server architecture. In one embodiment of the invention, the client software resides either on the user's computer or the service provider's server. The master authentication server and biometrics services server are network-based computer servers. The master authentication server is networked and in communication with the client software and the biometric services server. The biometric services server is networked and in communication with the master authentication server and includes a means for initiating contact with the user and accepting a biometric sample. Industry standard encryption components may also be included to ensure that the data communicated by the user is secure. This includes encryption via secure socket layer (SSL) and/or a non-PKI security solution.

In another embodiment of the invention, more than one type of biometric data is used to authenticate the user's identity. The invention employs voice analysis, fingerprint analysis, retina and eye scanning, face scanning, and other suitable biometric identifiers to authenticate identity. In the preferred embodiment, only one type of biometric data is typically used to authenticate identity. However, in an alternative embodiment, two or more types of biometric data (voice sample and fingerprint) or two or more biometric samples (fingerprint of right thumb and left ring finger) of the same type are used to heighten the accuracy of the authentication. Alternatively, the invention may employ random selection of two or more biometric data types or samples as additional methods of increasing reliability.

In another aspect of the invention, a user interface is provided to the user. The user interface allows the user to monitor authentication requests associated with the user as well as whether the requests were successful. The user interface optionally includes additional features such as allowing the user to select the type or number of biometric samples to be used for authentication.

In another embodiment of the present invention, in addition to authenticating the identity of the user, the system provides the service provider with selected personal information associated with the user stored in the master authentication server. This allows a user to maintain not only one identifier for a plurality of service providers, but also maintain a common current database of personal information that may be accessed securely by a plurality of services providers. This dispenses with the need for a user to maintain a keychain of identifiers/password pair for each service provider with whom the user desires to do business. This also allows a plurality of service providers to keep their records for a user current with minimal effort because the user's current personal information is stored in one secure location accessible by the service providers and the user.

In another embodiment of the present invention, a method for registering and enrolling a prospective user in the authentication system is provided. The registration process typically begins with a registration request from the user. Upon receipt of such a request, the user is queried for certain pre-selected personal information including the user's identity. This information is analyzed by and stored in the master authentication server, which generates and assigns a unique identifier associated with the user and generates a biometric template also associated with the user. The identifier and biometric template are stored in the master authentication server.

The master authentication server also generates a biometric enrollment request and communicates it to the biometric services server. After receiving a communication from the user, the biometric services server collects biometric specimens of a pre-determined type from the user and generates biometric data associated with these specimens. The biometric data is stored in the biometric services server. After successful collection of biometric specimens, the biometric services server communicates with the master authentication server and provides it information allowing the master authentication server to store data in the biometric template linking the template to the biometric data stored in the biometric services server.

In an alternative embodiment of the enrollment process, a session code is employed similar to the challenge code/response code discussed above. After receipt of a biometric enrollment request from the master authentication server, the biometric services server generates a unique session code and communicates it to the master authentication server, which communicates it to the user during enrollment. When the user initiates communication with the biometric services server to provide biometric specimens, the biometric services server queries the user for the unique session code before accepting the biometric specimens. In other embodiments of the invention, two or more biometric specimens of the same or a different type are collected from the user.

In another embodiment, the biometric specimen provided by the user is compared with pre-selected biometric data of known criminals or persons excluded from registering with the biometric authentication system. If there is a match, an enrollment rejection report is generated by the biometric services server. In yet another embodiment of the invention, more than one level of authentication may be assigned to a user based on pre-selected criteria. In another embodiment of the invention, the user presents the biometric specimens in the presence of an independent third party, who verifies that the identity of the person submitting the biometric specimen matches the identity provided by the user during enrollment.

Other objects, features, and advantages of the present invention will become apparent with reference to the drawings and detailed description that follow.

### BRIEF DESCRIPTION OF THE DRAWINGS

FIG. 1 is a block diagram illustrating one embodiment of the invention and illustrates user 30, service provider application 52, client software 100, master authentication server 200, and biometric services server 300, optional identity verification services 350, and optional user interface 370.

FIG. 2 is a block diagram illustrating registration process 500, enrollment process 600, optional service provider registration process 700, identify authentication process 800, and optional maintenance process 900.

FIG. 3 is a block diagram illustrating the IVAN verification request packet 104 and component parts according to one embodiment of the invention.

FIG. 4 is block diagram illustrating the flow of information provided to and requested from the user according to one embodiment of the invention.

FIG. 5 is a block diagram illustrating the registration process 500 and enrollment process 600.

### DESCRIPTION

In the following detailed description, reference is made to the accompanying drawings, which form a part hereof, and in which is shown by way of illustration specific preferred embodiments in which the invention may be practiced. These embodiments are described in sufficient detail to enable those skilled in the art to practice the invention, and it is understood that other embodiments may be utilized and that logical changes may be made without departing from the spirit or scope of the invention. To avoid detail not necessary to enable those skilled in the art to practice the invention, the description may omit certain information known to those skilled in the art. The following detailed description is, therefore, not to be taken in a limiting sense, and the scope of the present invention is defined only by the appended claims.

Overview of the Integrated Verification Authority Network

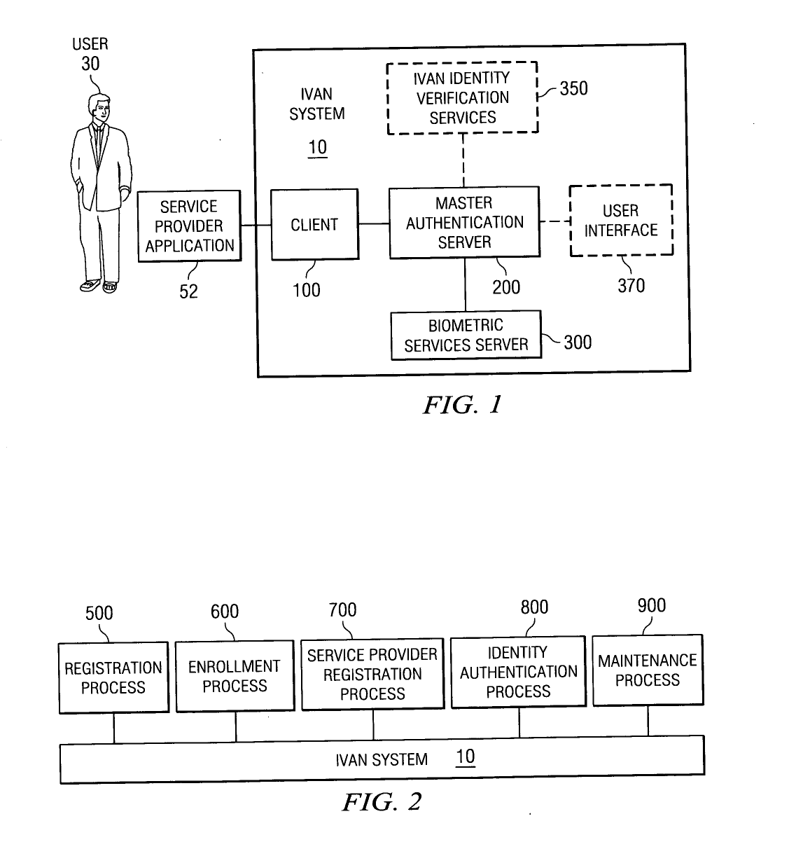

The following provides an overview of the preferred embodiment of the invention. As shown in FIG. 1, the Integrated Verification Authority Network system 10 (hereafter referred to also as “IVAN system”) is comprised of the client 100, master authentication server 200, biometric services server 300, and networking and other components. In addition, the IVAN system 10 optionally may include the IVAN identity verification services 350 and user interface 370. As shown in FIG. 2, the invention includes five processes. In the first process, a registrant 20 is enrolled with the IVAN system 10 as a user 30. During the enrollment process 500, the IVAN system verifies that the registrant 20 is the person he claims to be. Next, in the registration process 600, the registrant 20 provides biometric specimens 314 of predetermined type for analysis and association with the user's 30 registration. In the optional third process, referred to as the service provider registration process 700, the user 30 links his IVAN user account 32 with the processes of a desired service provider 50. This allows the user 30 and the service provider 50 to access to the IVAN system 10 for authentication of the user's 30 identity before accessing the service provider's 50 services. The fourth process is the user identity authentication process 800 through which the IVAN system 10 authenticates the user's identification using biometric analysis. Finally, during the optional fifth process, referred to as the maintenance process 900, the user's 30 profile 34 and biometric specifications are maintained.

The follow summarizes the user identity authentication process 800. As shown in FIG. 1, client 100 is provided as an add-on component to a service provider application 52 of service provider 50 (not shown). The service provider application 52 queries the user 30 for his service provider identifier 54 and optionally a service provider password 56 associated with the identifier 54. A first computer server, referred to as the master authentication server 200, and a second computer server, referred to as the biometric services server 300, are also provided. The service provider application 52 creates a verification request 60 for any service provider accounts 58 assigned to the user 30 linked to IVAN system 10 using the client 100 process. A response code 102 is generated by and stored on the client 100 as part of this step.

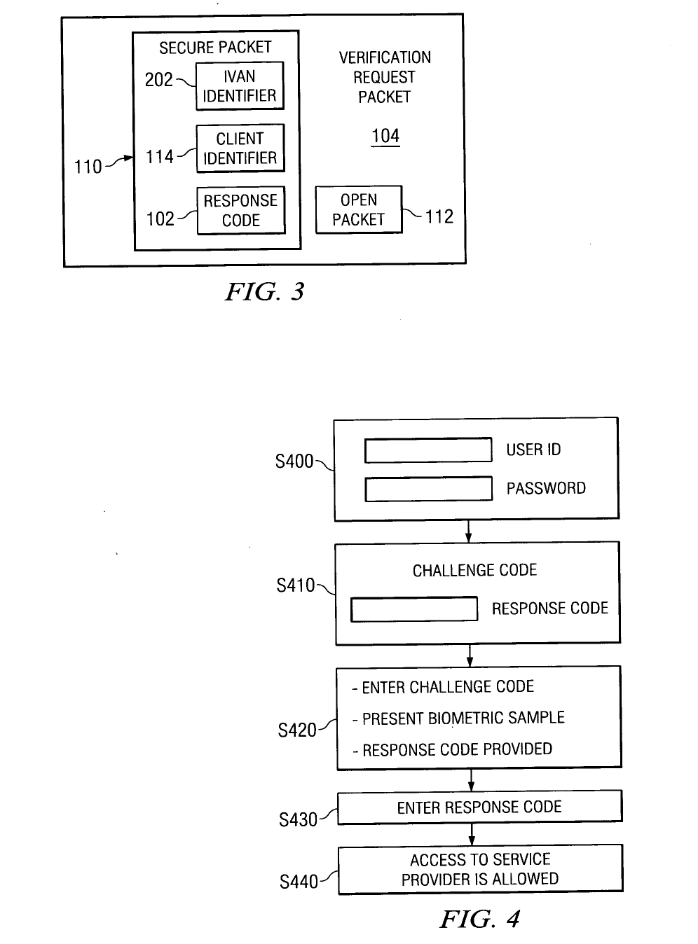

A verification request packet 104 is generated by the client 100 and transmitted to the master authentication server 200. As shown in FIG. 3., this verification request packet contains 104 two main parts; data elements 106 encrypted with a user's 30 public key 108, issued by IVAN 10, hereafter referred to as the secure packet 110, and a data element in clear text, hereafter referred to as the open packet 112. The secure packet 110 contains the unique IVAN identifier 202 for the user 30, the unique client identifier 114 for the service provider 50, and the response code 102. The open packet 112 contains the unique IVAN identifier 202 for the user 30.

In addition, the HTTPS protocol used for network transmission will provide the service provider's 50 IP address. The master authentication server 200 verifies the verification request packet 104 as follows: based on the unique identifier 202 for the user 30 found in the open packet 112, the user's 30 private key 204 is obtained and used to decrypt the secure packet 110. The unique user identifier 202 in the secure packet 110 is matched up with the unique user identifier 202 in the open packet 112. Further, the unique service provider identifier 114 is used to obtain a list of valid IP addresses for that service provider 50 to match up with the requester sending the verification request 60. If the private key 204 can decrypt the secure packet 110, and all values match, the verification request 60 is forwarded to the biometric services server 300.

The master authentication server 200 locates a biometric template 206 associated with the user 30, comprised of a biometric data identifier 208 and biometric data type 210 elements, and submits it along with the response code 102 to the biometric services server 300. Upon receiving the request, the biometric services server 300 generates a challenge code 302, and stores it along with the biometric data identifier 208 and the response code 102. The challenge code is communicated to and displayed by the service provider application 52 to the user 30. The biometric services server 300 then initiates communication with the user 30, or the user 30 initiates communication with the biometric services server 300. The user 30 then supplies the challenge code 302 to the biometric services server 300 to initiate the biometric authentication test 304. If the challenge code 302 is valid, the biometric services server 300 obtains the biometric sample 306 of a predetermined type corresponding to the challenge code 302 for analysis.

Upon receipt of the biometric sample 306 and verification that the biometric data 308 associated with the user 30 and the biometric sample 306 match, the biometric services server 300 provides the user 300 with the response code 102. The user 30 provides the response code 102 back to the service provider application 52, which validates the response code 102 with the client 100. Upon validation of the response code 102, the client 100 signals the service provider application 52 to proceed with allowing the user 30 further interaction with or access to the service provider application 52.

Turning to FIG. 4, a flowchart of the information requested from and communicated to the user 30 is provided. In step S400, the user is requested to supply a user identifier. This may be a user identifier supplied by the particular service provider (the service provider user identifier 54) or the user's 30 unique identifier supplied after successful enrollment and registration with the IVAN system 10 (the IVAN user identifier 202). Optionally, the user 30 may be queried to supply a unique password associated with the service provider identifier (the service provider user password 56). This adds an additional level of security to the authentication system. After the identifier is verified by the master authentication server 200, the user 30 is presented with a challenge code 302 and queried for a response code 102 as shown in step S410.

In the next step S420, the biometric services server 300 initiates contact with the user 30 and requests the user 30 to supply the challenge code 302. Upon successful receipt of the challenge code, the biometric services server 300 requests the user 30 to submit one or more biometric samples 306 of a pre-selected type. In the preferred embodiment, a voice sample is used for analysis and the communication to the user 30 is conducted by the biometric services server 300 via a telephone call 310. The biometric services server 300 then analyzes the biometric sample 306 provided by the user 30. If there is a match, the biometric services server 300 supplies the user 30 with the response code 102. As illustrated in steps S430 and S440, the user 30 then enters the response code 102 in either the client 100 or the service provider application 52, and following verification that the response code 102 is valid, the user 30 is granted access to the service provider 50.

IVAN Registration and Enrollment

The invention also includes registration and enrollment processes. Registration is generally the steps of collecting data regarding a prospective registrant 20, verifying the registrant's 20 identity, and initiating biometric enrollment. The enrollment process includes verifying the prospective registrant 20 has the proper session code 312, soliciting and accepting biometric specimens 314, and activating a user account 32 for the registrant 20. Both the registration and enrollment steps are collectively referred to as “biometric enrollment” and is initiated with an enrollment request. Preferably, registration is initiated from a website over the Internet although it may be initiated through a written application, telephone application, in person, and the like. FIG. 2 illustrates the registration 500 and enrollment 600 processes along with the service provider registration 700 and user identity authentication 800 processes.

In the initial registration stage, personal information such as name, address, social security number, etc. are entered by the prospective registrant 20. This information is used to verify that the prospective registrant is who he claims to be. In one embodiment, the level of confidence of the registrant's 20 identity may trigger a “pre-enrollment” status which, after the registrant 20 is biometrically enrolled in the system, may require follow-up biometric verification of the registrant 20 based on some form of official identification (i.e, Driver's License, Passport, etc.). In one embodiment of the invention, extensive information including telephone number and credit card numbers are collected during the initial registration stage 500 and are used to verify the potential registrant's 20 identity. In another embodiment, only basic information is collected and additional information is later requested if verification cannot be accomplished with a sufficient degree of confidence or if discrepancies are found. The personal information 212 submitted by the potential registrant 20 is stored in the master authentication server 200 and forwarded to the IVAN identity verification services 350. The registrant personal information 212 can be used later for additional verification processes as needed or during authentication of the identity of a registered user 30. The information can also be shared with service providers 50 as part of their customer record management (“CRM”) processes.

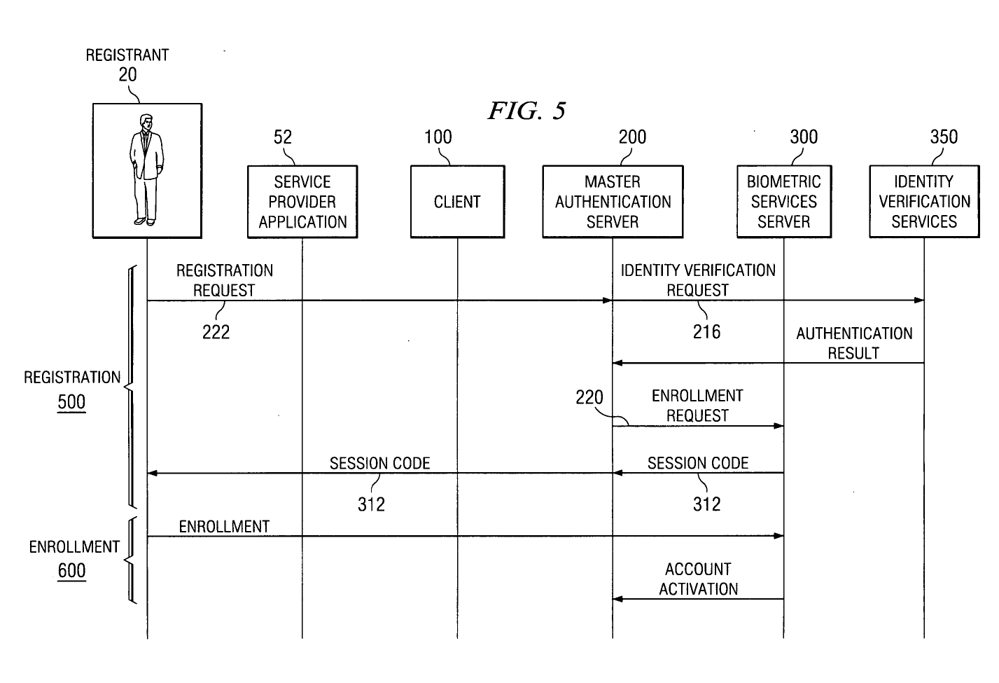

As shown in FIG. 5, enrollment is initiated by a registration request 222 request received by the master authentication server 200. This also can be referred to as an enrollment request. Once the potential registrant 20 supplies the necessary information, the master authentication server 200 generates a user master record 214 and a unique user identifier also referred to as the IVAN identifier 202. In the preferred embodiment, the IVAN identifier 202 is a string representing the social security number, date of birth, and country of residence of the registrant 20. Preferably, a hashing program is applied to this information such that it cannot be readily ascertained by third parties, who gain access to a user's 30 IVAN identifier 202. One skilled in the art will appreciate that other methods may be employed to generate the IVAN identifier 202 and secure it.

The master server 200 then initiates an identity verification request 216. Preferably, this request is sent to the IVAN identity verification services 350. In the preferred embodiment, the IVAN identity verification services 350 uses known third-party commercial verification services, such as Axiom, ChoicePoint, and Fair Isaac, to investigate the personal data 212 provided by the potential registrant 20 and checks the data against public data records to verify the identity of the potential registrant 20. If the potential registrant 20 is satisfactorily verified, the master authentication server 200 generates a public/private key pair 218, consisting of a private key 204 and matching public key 108, and associates the key pair 218 with the registrant's 20 unique IVAN identifier 202.

The master authentication server 200 also creates and sends an enrollment request 220 to the biometric services server 300. Upon receipt of the enrollment request 220, the biometric services server 300 generates a session code 312 comprised of a 7-digit number, which is unique within the scope of the currently active session codes. One skilled in the art will appreciate that any combination of numbers, alphabetical characters, and other characters may be used. The biometric services server 300 communicates the session code 312 to the master authentication server 200 and to the potential registrant 20. In preferred embodiment, the session code 312 is displayed on the website accessed by the potential registrant 20 to register with the IVAN system 10. The potential registrant 20 is also provided a telephone number to initiate communication with the biometric services server 300. Telephony, voice chat, and other communications means may also be employed.

After communication is established, the biometric services server 300 interrogates the potential registrant 20 for the appropriate session code 312. Upon successful transmission of the code 312, the biometric services server 300 then requests the registrant 20 to submit a predetermined type and number of voice biometric specimens 314 for analysis. The registrant 20 will be requested to submit a sufficient number of specimens so that the IVAN system 10 achieves an adequate biometric analysis for the registrant 20. Using commercially known technology, the biometric services server 300 analyzes the specimens 314 to create a biometric data extraction 316 of the specimens, which represent unique qualities and characterizations about the registrant 20 and his biometric specimens 314.

Examples of this technology includes Voice Trust (www.voicetrust.com.), Nuance (www.nuance.com.), and other solutions, which can be observed participating at biometric conferences (www.speechtek.com,www,bioAPI.org).

The biometric services server 300 then stores the biometric data extraction 316 and preferably the biometric specimens 314 in the biometric services server 300.

The biometric data extraction 316 and optionally the biometric specimens 314 comprise the biometric user data 318 also referred to as the “biometric data” 318. In one embodiment, the biometric user data 318 is comprised solely of the biometric data extraction 316. The biometric services server 300 also generates a biometric user data identifier 320 representing the location of the registrant's 20 biometric user data 318 in the biometric services server 300. This biometric user data identifier 320 is paired with the unique session code 312 and transmitted to the master authentication server 200. Upon receipt, the master authentication server 200 finds the biometric template 206 with the matching session code 312 and replaces the session code 312 in the template 206 with the biometric user data identifier 320. The biometric template 206 stored in the master authentication server 200 is now associated with the registrant's unique IVAN user identifier 202, stored in the master authentication server 200, and the registrant's biometric user data 318, stored in the biometric services server 300. Upon successful completion of this process, the registrant 20 is registered as a user 30.

Unlike other prior art applications, the IVAN biometric authentication system 10 of the current invention maintains a separation between the biometric templates 206 associated with the registered users 30 and the users's biometric user data 318 elements used for authenticating the users's 30 identification. Thus, the master authentication server 200 does not contain biometric user data 318, biometric specimens 314, or biometric data extractions 316 associated with users 30. Rather, these data elements are stored in the biometric services server 300. As an added security measure, the biometric services server 300 does not contain the IVAN user identifiers 202 associated with the users 30. This architecture makes it improbable, if not impossible, for a hacker to gain access to identifiable biometric data elements of previously authenticated users 30 without having to first hack into the master authentication server 200 to access the IVAN user identifiers 202, and the biometric data identifiers 208. To use this information, the hacker would have to hack a second time into the biometric services server 300 to gain access to the biometric user data 318, including the biometric data extractions 316 and biometric specimens 314, which are associated with users 30.

While the above embodiments include voice samples as the biometric of choice, biometric enrollment can include any existing biometric solutions available to be integrated into the IVAN system 10. Such biometrics solutions include fingerprint, facial recognition, iris, voice verification, and DNA. Examples of biometric analysis and techniques applicable to these technologies include FaceViTAL (http://www.gsdinc.com/eng), Nevision (http://www.nevenvision.com/), Iridian (http://www.iridiantech.com/), etc. These references are incorporated herein by reference. One skilled in the art will appreciate the number of alternative biometric techniques available to be employed with the IVAN system 10.

The invention is not limited to biometrics, which are quickly and inexpensively analyzed by present technology. For example, the IVAN system 10 can be adapted to accept DNA samples as the biometric specimen 314 to associate with the registrant 20. While technology currently does not provide for a commercially available, inexpensive, and quick DNA analysis means, DNA may still be employed as a biometric to verify the identity of the registrant 20 during the registration 500 and enrollment 600 processes. Moreover, as technology progresses and DNA analysis becomes more commercially available in the future, DNA can be adapted as the preferred biometric sample 306 solicited from users 30 by the IVAN system 10 during identity authentication processes 800. Since DNA samples were previously supplied and associated with registrants 20/users 30, the IVAN system 10 is readily adapted to meet the progression of technology with minimal reconfiguration.

In another aspect of the invention, multiple certifications of the identity verification 332 are provided. Rather than providing a single certification, that either the registrant 20 is verified or is not, the invention provides multiple levels of certifications corresponding to increasing levels of confidence of the identity verification. For example, the system 10 can be adapted to provide a first level of identity verification 332 corresponding to the registration/enrollment process described above. The system 10 can be adapted to provide a higher, second identity verification level 332 corresponding to the registrant 20 satisfying the first level process plus submitting additional information or biometric specimens. This can include providing such information and specimens to or in the presence of a trusted third-party administrator 360. A higher identity verification level 332 can be based, for example, on the registrant providing a DNA sample in the presence of a trusted third-party administrator 360 as well as valid government-issued photo identification corresponding to the registrant's 20 claimed identity. One skilled in the art will appreciate the multitude of levels or certification that can be provided based on varying information, biometric specimens, and supervision that may be employed with existing technology.

Additional information that can be used by the invention include driver's licenses, military identification, passports, and similar government-issued identification, preferably with a photograph. All of the personal information, including images of the photograph identifications, may be stored and associated with the registrant 20/user 30. The system 10 can further be adapted to collect more than one type of biometric specimen 314 during the registration/enrollment processes. For example, the registrant 20 can be asked to submit voice samples for voice analysis as well as a fingerprint and an iris scan. Any type of biometric specimen 314 suitable for analysis can be used by the invention during the registration/enrollment processes. This provides not only for enhanced confidence that the registrant 20 is the person he claims to be, but also enhances the operation and security of the IVAN system 10. As discussed below, by allowing the system 10 to choose from a multitude of biometric specimen types to solicit and analyze during an authentication operation, the confidence of the authentication process is enhanced and the chance of an imposter gaining access to the system 10 is lessened.

As discussed above, the IVAN system 10 can also be adapted to include trusted third-party administrators 360 to participate in and monitor the registration 500 and enrollment 600 processes. U.S. Patent Application No. US 2004/0059924 A1 filed by Soto et al. discusses the use of such third parties and is incorporated herein by reference. For example, the third-party administrators 360 can be used to witness or participate in the collection of the biometric specimens 314 during enrollment to ensure that the person submitting the sample is the person seeking registration. Similarly, the third-party administrator 360 can accept suitable identification of the registrant 20 to verify that it corresponds to the known identity of the registrant 20. In another aspect of the invention, a third party 360 administrates the registration 500 and enrollment 600 process in an office or kiosk type environment. In this embodiment, the registrant 20 supplies the proper personal data to the administrator 360 for analysis and verification. Upon verification, the administrator 360 supervises the registrant's 20 submission of the requisite biometric specimens 314. In another embodiment, the administrator 360 is involved only in the submission of the biometric specimens 314. This takes place after the IVAN identity verification services 350 has verified the registrant's 20 identity. Security can be enhanced by requiring the registrant 20 to submit the session code 312 to the third-party administrator 360 in addition to suitable identification.

In another embodiment of the invention, the biometric services server 300 compares the biometric specimens 314 and biometric data 318 to preselected biometric data. If there is a match, the biometric services server 300 will create an enrollment rejection report 326 and communicate it to the master authentication server 200, which in turn will deny enrollment of the registrant 20 into the IVAN system 10. This may be used to exclude known criminals, such as suspected identity thieves, suspected terrorists, criminals, and anyone else the administrator of the IVAN system 10 wishes to exclude.

IVAN Service Provider Registration

The IVAN system 10 is configured to work as a stand alone process or in coordination with service providers 50 to provide identity authentication for the service providers' users 30. Service providers 50 such as online banks, retailers, internet and email providers, etc. commonly employ a unique user identifier 54 and confidential password 56 pair as the typical user identity verification process. After the user 30 registers with the service provider 50 and creates a service provider user account 58, the user 30 is assigned a unique service provider identifier 54 associated with the account 58. The user then selects or is assigned a matching password 56 associated with the user identifier 54. The service provider 50 authenticates a user's 30 identity by requiring the user 30 to submit the confidential password 56 associated with the user identifier 54. Upon successful entry of the password 56, the user 30 is authenticated and gains access to the service provider's 50 services. This is normally accomplished by software associated with the service provider's application 52.

One disadvantage to the above process is that the user identifier 54/password 56 pair is susceptible to being either forgotten, lost, or stolen. This could result in the user 30 being unable to access the service provider's 50 services or worse, being the subject of an imposter gaining access to the user's 30 account 58 with the service provider 50 and being the victim of identity theft. The present invention addresses both of these concerns by employing a more reliable biometric authentication process that is not dependent on maintaining a confidential password. Moreover, as discussed in detail below, the present invention does not require the use of a service provider password 56, but a service provider password 56 may be used to enhance the security of the system.

After registering and enrolling with the IVAN system 10, a user 30 can link his IVAN user identifier 202 and the IVAN identity authentication system 10 to the service provider 50 and its application 52. Preferably, this accomplished by a web-enabled application referred to as the IVAN user interface 370 that allows the user 30 to access and manage the user's associated user profile 34. Typically, a list of linkable service providers 50 are displayed to the user 30 through the user interface 370. The user 30 then may select those service providers 50 to which he wishes to link to the IVAN system 10. After selecting the desired service providers 50 to link to the IVAN system 10, the user 30 will typically select the IVAN system authentication 10 as the preferred authentication method within the preferences of the user's 30 service provider account 58.

Service providers 50, who want to allow their users 30 to utilize the IVAN system 10 as part of their security protocol, will provide their standard security credentials used to provide user 30 verification. Upon verification, the service provider 50 will provide a process to allow the user 30 to establish the “link” between their IVAN user account 32 and their service provider user account 58. In one embodiment, this may include a user profile section with an area to record the user's IVAN account 32 and/or the user's IVAN identifier 202. Upon entering this information, the user 30 subsequently typically would get verified by the IVAN system 10 using the biometric verification process through which the user 30 was enrolled with the IVAN system 10. Upon successful verification, the IVAN account 32 would be flagged as registered with the service provider's user account 58, thus, allowing the IVAN system 10 to participate as the overall security verification of the service provider 50.

Another advantage of this invention is that a user 30 need only one identifier, his IVAN identifier 202, to access a plurality of different service providers 50. This eliminates the need for a large number of user identifiers/password pairs for each service provider 50 associated with a user 30. By eliminating these excess user identifier/password pairs, a user 30 is less likely to forget his identifier or unknowingly grant access to it to an unauthorized third party. This increases the overall security for the service providers 50 and lessens the chances of identity theft.

In another embodiment of the invention, selected personal information 212 stored in the master authentication server 200 is made available to a plurality of service providers 50 associated with or linked to a particular user's 30 IVAN user identifier 202. This provides several advantages. This information may be used as part of a service provider's 50 CRM data program. First, like his identifier 202, the user 30 only needs to maintain one centralized storage of personal data for the service providers 50. This not only alleviates the user's 30 burden of providing the same personal information to each service provider 50 separately, but also allows the user 30 to keep his personal data current for each provider 50 by keeping his IVAN account data current. Second, by obtaining data from the IVAN system 10, the service provider 50 has greater assurance that the data is accurate and third, the service provider 50 is better able to keep up with changes in the personal data of its IVAN users 30. According to one aspect of the invention, the user 30 selects the information to be made available to the service providers 50. This allows the user 30 to give a particular service provider 50 access to all of the user's 30 personal information or only selected portions of the information.

In one embodiment of the invention, the service provider 50 is provided with all personal data associated with the user 30 that has changed since the user's 30 last log in. This results in greatly reduced CRM costs for the service provider 50. In the preferred embodiment, the service provider 50 is not provided a user's personal data 212 or changes to the data until after a successful authentication process has been performed. This ensures that the service provider 50 requesting the information is authorized to gain such information and likewise that the user 30 desiring to share that information is the registered user 30.

IVAN Identity Verification and Authentication

As discussed above and shown in FIG. 1, the IVAN system 10 is comprised of the client 100, master authentication server 200, biometric services server 300, and networking and other components. In addition, the IVAN system 10 optionally may include the IVAN identity verification services 350 and user interface 370. The client 100 can either be a stand-alone application or it may be integrated within the web server or network of the service provider 50. In the latter case, the operation of the client 100 is largely invisible to the user 30. As discussed above, the log in step includes entry by the user 30 of a user identifier 54 and typically a password 56 associated with the service provider 50 or the user 30 may enter his IVAN user identifier 202. If the service provider user identifier 54 and password 56 are used, the client 100 will determine if an IVAN user identifier 202 is associated with the service provider user identifier 54. If so, the client 100 submits a verification request 1 16 to the master authentication server 100 in the form of a verification request packet 104.

According to one aspect of the invention, a verification request packet 104 is generated by the client 100 and transmitted to the master authentication server 200. As shown in FIG. 3., this verification request packet 104 contains two main parts; data elements 106 encrypted with a user's 30 public key 108, issued by IVAN, hereafter referred to as the secure packet 110, and a data element in clear text, hereafter referred to as the open packet 112. The secure packet 110 contains the unique IVAN identifier 202 for the user 10, the unique client identifier 114 for the service provider 50 and the response code 102. The open packet 112 contains the unique IVAN identifier 202 for the user 10. The client identifier 114 is a unique identifier corresponding to the service provider 50 and preferably, is associated with one or more known IP addresses. Inclusion of associated IP addresses enhances security of the communications and authentication process. The response code 102 is typically a unique 7-digit number and is generated by the client 100. One skilled in the art will appreciate that any combination of numbers, alphabetical characters, and other characters may be used to generate the response code so long as the response code is reasonably secure from third-party discovery.

The secure packet 110 is encrypted using PKI with a public key associated with the user 30 and the user's IVAN user identifier 202. As with conventional PKI, the invention uses public key cryptography such as that based on PKCS to ensure the confidentiality of the data and communications sent to and from the client 100 to the authentication server 200. It also validates the authenticity of the service provider 50, as the verification request packet 104 would be deemed invalid if the decryption of the packet fails.

In certain aspects of the invention, the client 100 may also include biometric collection devices 118 and associated software 120 (e.g. fingerprint scanning and characterization, retinal scanning and characterization, facing scanning and characterization, etc.), as well as encryption/decryption software 122 for communicating with the master authentication server 200. The client 100 may use network communication technology protocols known in the art such as HTTPS, TCP/IP, and SSL and as described below. The particular computer or telecommunication device associated with the client 100 is incidental to the invention and can include personal computers (PCs), laptops, notebooks, personal digital assistants (PDAs), other handheld devices, cellular telephones, and smart phones.

The master authentication server 200 decrypts the secure packet 110 using a private key 204 associated with the user 30 and the user's IVAN user identifier 202. The private key 204 is ascertained from a table or database containing IVAN user identifiers 202 associated with private keys 204. Following decryption of the secure packet 110, the master authentication server 200 determines whether the IVAN user identifier 202 is valid and active. This is accomplished by querying a database or data store 224 of registered IVAN user identifiers 202 and the status of the identifiers 202. The database or data store 224 may be included with the master authentication server 200 or may be remote from the server. Additionally, in the preferred embodiment, the master authentication server 200 ensures that the IP address of the client 100 matches the IP addresses stored for that particular client 100.

In one aspect of the invention, the system requires periodic maintenance of the IVAN user identifiers 202 and biometric user data 318. Because a person's biometric characteristics, such as voice, may change with age or other events and conditions, it is desirable to include a process by which a user 30 must provide up-to-date additional biometric specimens 314. This periodic maintenance can also be used to maintain the integrity of the user 30 to lessen the chance that imposters have enrolled into the IVAN system 10. Yet another process that may be employed is to require a user 30 to submit more than one type of biometric specimen 314 (e.g. a voice sample followed by a scan of the left thumb followed by a retinal scan of the right eye) either during the registration 500 and enrollment 600 processes or later during the optional maintenance stage 900. These steps will lessen the chance of inaccurate identity authentication and increase the overall integrity of the IVAN system 10. Finally, the invention is also adapted to optionally require users 30 to pay a membership or registration fee periodically to maintain the authentication service.

As a result of the above features, a number of different statuses and flags may be assigned to an IVAN user identifier 202: (1) registered, in the case of a user 30 who has completed the registration process 500 and the enrollment process 600; (2) registration pending, for a user 30 who has commenced enrollment but has not completed it; (3) registration denied, for a user 30 that has either failed the registration process or a user 30 whom the IVAN administrator wishes to exclude from the network; (4) maintenance required, for a user 30 who is required to provide the above-discussed maintenance, but who has not completed the maintenance; and (5) registration suspended, for an otherwise validly registered user 30, who has failed to submit a membership fee or conducted periodic maintenance. One skilled in the art will recognize a multitude of different registration statuses and flags that may be assigned to a particular IVAN user 30 identifier 202 without departing from the spirit of the present invention.

If the master authentication server 200 determines that the IVAN user identifier 202 is both registered and valid, the master authentication server 200 then locates a biometric template 206 associated with the user's IVAN user identifier. The biometric template 206 contains data regarding the type of biometric specimen 314 associated with the user 30 (e.g. voice, fingerprint, iris, face, etc.) referred to as the biometric data type 210. The biometric template 206 also contains the biometric data identifier 208,which corresponds to the location of the biometric user data 318 associated with user 30 stored in the biometric services server 300. The master authentication server 200 sends the biometric services server 300 an authentication request 226 containing the selected biometric data identifier 208 and the response code 102.

The IVAN system 10 is adapted to collect more than one biometric template 206 per registered user 30. This allows for collection of multiple biometric specimens 314, including samples of different type (e.g. voice, fingerprint, iris, face, etc.). As one skilled in the art will appreciate, the more biometric specimens to compare against a user 30 seeking identity authentication, the greater the likelihood that an imposter will not be able to gain erroneous authentication. In another embodiment of the invention, the client 100 or the master authentication server 200 selects the type of biometric template or number of templates to be used by the biometric services server 300 to authenticate the user 30. For example, each time a particular user 30 requests authentication the various biometric templates 206 associated with the user 30 could be cycled (assuming there are at least three) so that the same one is not used twice in a row. Alternatively, random selection can be applied to the selection of the biometric templates 206.

In some cases, the user 30 may wish to specify the type of biometric sample 306 to submit depending on the circumstances. For example, if a fingerprint-imaging device is not present, the user 30 may wish to submit a voice sample or an iris scan. The IVAN system 10 is configured to accommodate such requests. Additionally, where varying levels of authentication status are employed, more than one biometric template 206 may be used by the biometric services server 300 to authenticate identity. For a level one authentication, analysis of only one biometric sample 306 is employed; whereas, a level 2 authentication could require analysis of two or more biometric samples 306. One skilled in the art will appreciate the number of levels and variations that may be employed depending on the objectives to be achieved.

The communications between the master authentication server 200 and the biometric services server 300 are performed over a private, secured network, inaccessible to third parties according to principals of current network security standards implemented with equipment such as routers and firewalls.

As discussed above, the master authentication server 200 initiates identify authentication by sending an authentication request 226 to the biometric services server 300. This packet contains the selected IVAN user's 30 biometric data identifier 208 and the response code 102 generated by the client 100. After receipt of the authentication request 226, the biometric services server 300 generates a session record 322 related to the particular authentication transaction. These session records 322 are all transient with a predetermined expiration time, which gives the user 30 a window of opportunity to complete the identity authentication process 800. Preferably, the only outward link between an IVAN account 32 and its related biometric data 318 is the user's 30 knowledge of the challenge code 302 for authentication 800. If an invalid challenge code 302 is presented, the biometric services server 300 will log the attempt and inform the user 30 to obtain a valid challenge code 302.

Additionally, the biometric services server 300 generates a challenge code 302 comprised of a 7-character string and communicates that code to the master authentication server 200, which in turns communicates it to the client 100. One skilled in the art will appreciate that any combination of numbers, alphabetical characters, and other characters may be used so long as the challenge code is reasonably secure from third-party discovery. After receipt, the client 100 causes the challenge code 302 to be communicated to the user 30 and queries the user 30 for entry of an appropriate response code 102. Use of a challenge code 302 is not an essential aspect of the invention, but results in heightened security of the identify authentication process 800 and therefore is preferred.

If biometric user data 318 corresponding to the user's 30 biometric data identifier 208 is located, the biometric services server 300 initiates communication with the user 30. In the preferred embodiment, this is accomplished through a telephone call 310 to a pre-selected telephone number. In other implementations of the invention, the biometric services server 300 can initiate communication by prompting the user 10 via a computer or other device interface, telephony, voicechat, other communication devices, and the like to enter a selected biometric sample 306 or series of samples. One skilled in the art would appreciate that the invention is not limited to any particular method of communication and those methods known in the art and their equivalents are suitable.

After the user 30 responds to the communication, the biometric services server 300 requests submission of the challenge code 302. If the appropriate code is provided, the biometric services server 300 will then request the user 30 to provide one or more biometric samples 306. For example, in the preferred embodiment, the biometric services server 300 initiates a telephone call 310 to the user 30, and queries the user 30 for the challenge code 302 and a voice sample. Analytical methods and algorithms relating to voice identification are well known in the art. Examples include the initial speaker verification engine developed at Rutgers University in early 1990s, Nuance, Scansoft, etc. (http://www.caip.rutgers.edu/multimedia/speech-recognition.html).

Similar methods and algorithms related to iris scanning, fingerprinting analysis, and face scanning are also known in the art. All references cited herein are incorporated by reference to the maximum extent allowable by law. To the extent a reference may not be fully incorporated herein, it is incorporated by reference for background purposes and indicative of the knowledge of one of ordinary skill in the art.

If the biometric services server 300 determines that there is a positive match between the biometric sample 306 presented and the biometric user data 318 associated with the user 30, the biometric services server 300 provides the user 30 with the response code 102 and sends the master authentication server 200 a positive authentication report 324 that the user 30 has been authenticated. Next, the user 30 enters the appropriate response code 102 into the service provider application 52. The client 100 determines whether the response code 102 entered matches the response code 102 stored in the client 100 associated with the IVAN user identifier 202. If there is a match, the user 30 is granted access to the service provider 50. If the biometric services server 300 does not find a positive match between the biometric sample 306 presented and the biometric user data 318, the biometric services server 300 will generate a negative authentication report 324 and preferably log the attempted authentication. The biometric services server 300 communicates the negative authentication report 324 to the master authentication server 200, which denies the identity authentication request.

In another embodiment of the invention, the biometric sample or samples 306 are compared against selected biometric data. If there is a match, the biometric services server 300 will create an authentication rejection report 328 and communicate it to the master authentication server 200. Typically, the user's 30 identity authentication request will be terminated at that point. This may be used to exclude known criminals, such as suspected identity thieves, suspected terrorists, criminals, and anyone else the administrator of the IVAN system 10 wishes to exclude from the system. Because the IVAN system 10 is dynamic and adapted to add additional users, this control operates to exclude previously registered users 30, who are deemed to be no longer desirable to the system 10 or who have appeared on a watch list since their registration/enrollment with the system 10. This enhances the overall security of the system 10 and provides a greater confidence in the accuracy of the identity authentication operation.

Other measures that may be employed consistent with the invention include requiring a user 30 to submit one or more additional biometric samples 306 after the initial sample 306 is collected, but before the biometric services server 300 generates the authentication report 324. For example, this may be desirable where the match between the biometric user data 318 and the biometric sample 306 falls outside acceptable criteria.

An additional optional feature is the inclusion of an authentication confidence report 330 associated with the analysis of the biometric sample 306 submitted by the user 30. The IVAN system 10 is adapted to associate a number of authentication confidence reports 330 relative to predetermined conditions or criteria associated with the user 30 and/or the results of the biometric analysis of the submitted biometric sample 306. Such conditions can include: (1) where the match between the biometric user data 318 and the biometric sample 306 falls toward the lower end of the acceptable range; (2) where the match between the biometric user data 318 and the biometric sample 306 falls toward the middle of the acceptable range; (3) where the match between the biometric user data 318 and the biometric sample 306 falls toward the highest end of the acceptable range; (4) where more than one biometric sample has been collected and verified; and (5) where the user has been assigned a higher identity verification certification 332 during the registration/enrollment processes. The biometric services server 300 can be adapted to create and return an authentication confidence report 330 for a particular authentication request 226, and can be further adapted to take additional actions based upon the level of the authentication confidence report 330, such as issuing an authentication rejection report 328 or requiring the user 30 to submit additional biometric samples 306 of the same or different data type.

IVAN user interface

In another aspect of the invention, the IVAN system 10 provides the user 30 with a web-enabled application referred to as the IVAN user interface 370 that allows the user 30 to edit his user profile 34. For example, the IVAN system 10 can be adapted to allow the user 30 to select the type of preferred biometric (voice, fingerprint, face recognition, iris) used for authentication, whether the user 30 wishes more than one type of specimen analyzed, and whether the user 30 wishes the specimens to be randomly selected from a pre-determined list. Through the user interface 370, the user 30 can also select a heightened authentication level, as discussed above, and initiate the process of providing additional information or specimens as are required to gain the heightened authentication level.

The IVAN user interface 370 can also be used for maintenance of the user's 30 IVAN account 32. If the IVAN user account 32 is set up to require the user 30 to pay periodic maintenance fees, this can be accomplished through the user interface 370 or other known commercial methods. Additionally, as discussed above, the IVAN system 10 can be configured to require the user 30 to submit updated biometric specimens to maintain his registration or to submit new biometric specimens as technology evolves to enhance the overall security and accuracy of the IVAN system 10. This allows the IVAN system 10 to be continuously updated as new biometric or other identity authentication technology emerges.

Additionally, the IVAN user interface 370 can be adapted to allow the user 30 to monitor the number of authentication requests and results made in connection with the user's 30 IVAN identifier 202. This allows a user 30 to determine whether an imposter has gained access to his IVAN identifier 202 and made attempts to be authenticated as the user 30 or gained access to the service providers 50 associated with the user 30. By providing the user 30 access to such information, the security of the IVAN system 10 is enhanced. One skilled in the art will appreciate that additional information and options may be provided to the user 30 through the user interface 370 consistent with the invention.

As can be readily seen by one skilled in the art, the primary advantage of the present invention is a quick and relatively effortless authentication of a user's 30 identity while at the same time maintaining a highly secure identity authentication process, not susceptible to third-party intervention. As discussed above in detail, one way this is accomplished is through a separation between the IVAN user identifiers 202 and biometric templates 206 stored in the master authentication server 200 and the biometric user data 318 stored separately on the biometric service server 300. Other advantages of the present invention include a global authentication network, which users 30 can leverage across companies and applications as long as these are tied into the IVAN network 10. This could reduce the burden individual companies face today with users 30 forgetting their passwords and/or credentials as the users 30 at this point are only required to remember their IVAN user identifier 202 to authenticate with the IVAN network 10 to gain access to a plurality of different service providers 50. Yet another advantage of the present invention is that it allows users to maintain their personal data and keep it current in one location, but available to a plurality of service providers. Similarly, service providers with access to IVAN user data can keep their CRM records current with less costs, and more confidence that the records are accurate.

Even though many of the examples of the invention discussed herein relate to allowing users 30 access to a software application, the present invention also can be applied to other types of scenarios requiring secured access, such as physical access control, call center IVRs, credit-card activations, access to medical records, and electronic payments for point-of-sale transactions. Since biometrics are an extra layer of security and work with software applications due to the standardization and open interface design, the technologies integrated in today's facilities and infrastructure can be integrated with the biometric layer. Today's society is technically advanced from year's ago, thus, allowing incorporation of biometrics in all aspects of society.

One skilled in the art will appreciate that the present invention can be applied in many areas where there is a need to provide secured, authenticated, and logged access or transaction approval. It should be apparent from the foregoing that an invention having significant advantages has been provided. While the invention is shown in only a few of its forms, it is not just limited but is susceptible to various changes and modifications without departing from the spirit thereof.

We claim:

1. A method of authenticating the identity of a user via biometric analysis, the method comprising:
a. querying the user for an identifier associated with the user;
b. selecting at least one biometric template associated with the identifier, the identifier and biometric template stored in a first computer server;
c. selecting biometric data stored in a second computer server associated with the biometric template, the second computer server storing the biometric data but not the identifier or the biometric template;
d. collecting a biometric sample from the user;
e. comparing the biometric sample with the biometric data and verifying that the biometric sample and the biometric data match; and
f. generating an authentication report if the biometric sample matches the biometric data.

2. The method of claim 1 wherein the biometric sample is a voice sample.

3. The method of claim 2 wherein the voice sample is collected by the second computer server after initiating a telephone call to the user.

4. The method of claim 1 wherein at least two biometric templates stored in the first computer server are selected for analysis and biometric samples are collected from the user and compared with the biometric data associated with the selected biometric templates to verify that the biometric samples and biometric data match.

5. The method of claim 4 wherein the biometric samples collected from the user are comprised of at least two different biometric data types.

6. The method of claim 1 further including the steps of comparing the biometric sample provided by the user with selected biometric data and generating an authentication rejection report if there is a match between the biometric sample and the selected biometric data.

7. The method of claim 1 further including the step of generating an authentication confidence report associated with the authentication report, the authentication confidence report chosen from a menu of two or more different levels of authentication confidence reports based on predetermined criteria.

8. The method of claim 7 further including the steps of collecting a second biometric sample from the user, comparing the second biometric sample with the biometric data, and verifying whether there is a match between the second biometric sample and the biometric data upon the occurrence of a selected authentication confidence report before generating an authentication report.

9. A method of authenticating the identity of a user via biometric analysis, the method comprising:
a. querying the user for an identifier associated with the user;
b. generating a challenge code;
c. communicating to the user the challenge code;
d. selecting at least one biometric template associated with the identifier, the identifier and biometric template stored in a first computer server;
e. selecting biometric data stored in a second computer server associated with the biometric template, the second computer server storing the biometric data but not the identifier or biometric template;
f. initiating communication with the user and querying the user for the challenge code;
g. collecting a biometric sample from the user, if the challenge code is received;
h. comparing the biometric sample with the biometric data and verifying that the biometric sample and the biometric data match; and
i. generating a positive authentication report if the biometric sample matches the biometric data.

10. The method of claim 9 further including the steps of generating a response code associated with the challenge code, querying the user for the response code, providing the user with the response code if a positive authentication report is generated, and providing the user access to a service provider upon collection of the response code.

11. The method claim 9 further including the step of verifying that the user is registered before collecting the biometric sample from the user.

12. The method of claim 9 further including the step of collecting a second biometric sample from the user before generating the authentication report upon the occurrence of a predetermined condition.

13. A method of authenticating via biometric analysis the identity of a user of a service provider application on a computer network to provide the user access to services provided by a service provider, the method comprising:
a. receiving a request for access to services;
b. querying the user for a first identifier associated with the user provided by the service provider and selecting a second identifier associated with the first identifier, the second identifier stored in a client in communication with the service provider application;
c. selecting at least one biometric template associated with the second identifier, the biometric template stored in a first computer server in communication with the client;
d. selecting biometric data associated with the biometric template stored in a second computer server, the second computer server in communication with the first computer server and storing the biometric data but not the identifier or biometric template;
e. collecting a biometric sample from the user;
f. comparing the biometric sample with the biometric data and verifying that the biometric sample and the biometric data match;
g. generating a positive authentication report if the biometric sample matches the biometric data; and
h. providing the user access to the service provider if a positive authentication report is generated.

14. The method of claim 13 further including the steps of making a record of the request for access associated with the user and providing the user an interface through which the user can access the record of the request for access.

15. The method of claim 13 wherein the step of selecting the biometric template further includes querying the service provider application for the type of biometric data to be used for the biometric analysis and selecting a biometric template associated with the second identifier of a biometric data type corresponding to the type of biometric data provided by the service provider application.

16. An apparatus for authenticating via biometric analysis the identity of a user on a computer network, the apparatus comprising:
(a) a client for receiving a request for identity authentication from a user, the client in communication with a first computer server;
(b) the first computer server storing a unique identifier associated with the user and at least biometric template associated with the identifier, the first computer server in communication with a second computer server;
(c) the second computer server storing biometric data associated with the biometric template, but not storing identifiers or biometric templates, wherein the second computer server is adapted to collect a biometric sample from the user, compare the biometric sample with the biometric data, verify that the biometric sample and the biometric data match, and generate a positive authentication report if the biometric sample and the biometric data match; and
(d) a means for communicating the authentication report.

17. The apparatus of claim 16 further including a user interface in communication with the first computer server, the user interface adapted to allow the user to select the type of biometric sample collected from the user during identity authentication request operation.

18. The apparatus of claim 16 further including a user interface in communication with the first computer server, the user interface adapted to allow the user to select the number of biometric samples collected from the user during identity authentication request operation.

19. The apparatus of claim 16 further including a user interface, in communication with the first computer server, adapted to require the user to submit a biometric specimen upon the occurrence of a predetermined condition, wherein the biometric specimen is collected by the second computer server and biometric data associated with the biometric specimen is generated by the second computer server and stored in the second computer server and associated with the identifier associated with the user.

20. The apparatus of claim 16 wherein the client includes a means for linking a plurality of service providers to the client so that the user may initiate a request for identity authentication directly from a website provided by any of the plurality of service providers.

21. The apparatus of claim 20 wherein:
(a) the client is adapted to generate a response code and communicates the response code to the second computer server, which generates a challenge code associated with the response code, the client further adapted to communicate the challenge code to the user and query the user for the response code and upon successful communication of the response code, the client provides the user access to the service provider; and
(b) the second computer server is adapted to collect the biometric sample from the user only after receipt of the challenge code from the user and is further adapted to communicate the response code to the user after verifying that the biometric sample collected from the user and the biometric data match.

22. The apparatus of claim 20 wherein the first computer server is adapted to store personal information associated with the user and communicate selected portions of the personal information to at least one of the linked service providers.

23. A method of enrolling a user in a biometric identity authentication system, the method comprising:
(a) receiving a request for enrollment from the user;
(b) querying the user for selected personal information including the user's identity and storing the personal information in a first computer server;
(c) analyzing the personal information;
(d) generating and assigning a unique identifier associated with the user, the identifier stored in the first computer server;
(e) generating a biometric template associated with the identifier and storing it in the first computer server;
(f) receiving a request to submit at least one biometric specimen from the user and collecting one or more biometric specimens of a predetermined type from the user, collection performed by a second computer server;
(g) generating biometric data associated with the biometric specimens and storing the biometric data in the second computer server; and
(h) associating the biometric template with the biometric data.

24. The method of claim 23 further including the steps of:
(a) generating a session code and storing it in the second computer server; (b) communicating the session code to the user; and
(c) after receiving a request to submit biometric specimens from the user, querying the user for the session code and comparing the session code collected from the user with the session code stored in the second computer server before collecting one or more biometric specimens from the user.

25. The method of claim 23 wherein at least two biometric specimens of different biometric data types are collected from the user by the second computer server.

26. The method of claim 23 wherein the biometric specimen is a voice specimen.

27. The method of claim 26 wherein the voice specimen is collected by the second computer server after receiving a telephone call from the user.

28. The method of claim 23 wherein at least two biometric specimens of the same biometric data type are collected from the user by the second computer server.

29. The method of claim 23 further comprising the steps of comparing the biometric specimen provided by the user against selected biometric data and generating an enrollment rejection report if there is a match between the biometric specimen and the selected biometric data.

30. The method of claim 23 wherein at least some of the personal information collected from the user is received in a face-to-face transaction by a person and further including the step of verifying that the identity of the user presenting the personal information matches the identity claimed during enrollment step 23(b).

31. The method of claim 23 further including the step of assigning an identity verification certification associated with the user from a menu of at least two identity verification certifications corresponding to predetermined criteria.

32. The method of claim 23 further including the step of collecting additional biometric specimens from the user upon the occurrence of a predetermined condition.

33. An apparatus for enrolling a user in a biometric identity authentication system, the apparatus comprising:
(a) a first computer server adapted to accept personal information provided by a user wishing to be enrolled biometrically and to analyze that information and generate and store a unique identifier and biometric template associated with the user;
(b) a second computer server in communication with the first computer server, the second computer server adapted to collect a biometric specimen of a pre-determined type from the user, generate biometric data associated with the biometric specimen, and store the biometric data in the second computer server, the second computer server further adapted to generate an enrollment report and communicate it to the first computer server, which associates the biometric template stored in the first computer server and the biometric data stored in the second computer server; and
(c) a means for communication between the user and the second computer server through which the second computer server collects the biometric specimen from the user.

34. The apparatus of claim 33 wherein the communication means is a telephone call and the biometric specimen collected by the second computer server is a voice sample.
